(19) United States
(12) Patent Application Publication
(10) Pub. No.: US 2007/0224409 A1
(43) Pub. Date: Sep. 27, 2007

(54) Wipe Product, and Methods of Making

(76) Inventors: James R. DOVORANY, Lake Elmo, MN (US); Stanley F. Alexander, Plymouth, MN (US)

Correspondence Address: MERCHANT & GOULD PC, P.O. BOX 2903, MINNEAPOLIS, MN, 55402-0903, US

(21) Appl. No.: 11/277,402

(22) Filed: Mar. 24, 2006

(51) Int. Cl. B32B 3/26; D21H 11/00; B32B 3/00; D21H 13/00

(52) U.S. Cl. 428/304.4; 428/314.4; 428/314.8; 428/311.51

(57) ABSTRACT

A flexible, durable, multiple use article, such as a wipe. The wipe has two layers, one layer being an open cell melamine-based foam and the second being carrier layer for the melamine-based foam layer, providing flexural strength to the foam. The carrier layer could be a foam or other material. The wipe may be one of a plurality of wipes, provided in a package.

### FIELD

The present invention relates to the field of thin, flexible articles, such as used for cleaning, the flexible articles comprising at least one layer of foam material.

### BACKGROUND OF THE INVENTION

Rags, cloths, mops, etc. are conventionally used for both residential and professional cleaning. Generally, these cleaning articles are made from cloth or fabric, in particular, cotton, which is fairly soft and non-abrading. Sponges are non-cloth articles also used for both residential and professional cleaning. Sponges, rags, cloths, and mops also have liquid-absorbing capacity, and appropriate strength and resistance for their use, (e.g., dust removal, floor washing, dish washing). Often, these articles are used in conjunction with a cleanser or detergent.

Sponges, rags, cloths, and other cleaning articles are often intended for repeated use. They have appropriate strength and resistance to have an acceptably long service life. Typically after use, these articles are rinsed and/or washed.

There is always room for improvement for cleaning and wiping articles.

### SUMMARY OF THE INVENTION

The present invention provides an article that provides cleaning and wiping capabilities, with the absorbency of a sponge, and without the need for added cleansers or detergents. Although the article is suitable for use in dry application, it is particularly configured to be used in wet environment. In preferred embodiments, the article is a flexible, sheet-like article, which can be referred to as a wipe. The wipe has two layers, one layer being an open cell melamine-based foam. The second layer is carrier layer for the melamine-based foam layer, providing flexural strength to the foam.

In one particular aspect, the invention is to a wipe that has an open cell melamine-based foam layer having a thickness of about 1-3 mm, and a carrier layer continuous and contiguous with, and adhesively attached to, the melamine-based foam layer. Preferably, the carrier layer is not open cell melamine-based foam. The melamine-based foam layer could have a thickness of about 2 mm. The carrier layer can be, for example, a foam material, such as polystyrene, polyester, polyurethane, or a combination thereof, or can be, for example, a nonwoven material. The wipe may be provided together with a plurality of wipes, such as in a roll or stack.

In another aspect, the invention is to a method of making an article, such as a wipe, the method including forming a plurality of thin layers from a thick layer of melamine based-foam material. One of the resulting thin layers of melamine based-foam material can be adhered to a carrier layer. To form the plurality of thin layers from the thick layer, this could be done by slitting the thick layer of melamine based-foam material, for example, across the large face of a block.

These and various other features which characterize the invention are pointed out with particularity in the attached claims. For a better understanding of the sensors of the invention, their advantages, their use and objectives obtained by their use, reference should be made to the drawings and to the accompanying description, in which there is illustrated and described preferred embodiments of the invention.

### BRIEF DESCRIPTION OF THE DRAWINGS

Referring now to the drawings, wherein like reference numerals and letters indicate corresponding structure throughout the several views:

FIG. 1 is perspective view of a wipe in accordance with the principles of the present invention;

FIG. 2 is a perspective view of a plurality of wipes in a first configuration; and

FIG. 3 is a side view of a plurality of wipes in a second configuration.

### DETAILED DESCRIPTION

The present invention provides a multi-layer wipe, suitable for cleaning (such as dusting, scrubbing, erasing, etc.) surfaces. The wipe is a multiple use article, being sufficiently rigid and sturdy for multiple uses. The wipe is sufficiently cost-effective to be disposed of after use.

Examples of wet applications for using the wipe include: removing scuffs, stains, and other marks (e.g., marker, Crayon) from painted walls; cleaning pots, pans and other bake ware and cookware, particularly stainless steel; removing scuffs and shoe marks from tile floors; cleaning dirt and residue from resin based patio furniture; cleaning brake dust, road salt and road grime off of aluminum wheels for vehicles such as cars, trucks, or motorcycles; cleaning bugs from windshields, windows and headlamps; cleaning dirty water marks off boat hulls; and cleaning chrome, stainless steel and aluminum trim on vehicles. Examples of dry applications for the wipe include: removing smoke residue from glass fireplace doors and the surround; cleaning fingerprints and other marks from stainless steel appliances; and removing haze and streaks from surfaces cleaned with cleaner, such as mirrors, windows and other glass. The wipe could be used for numerous other wet or dry applications that are not listed here.

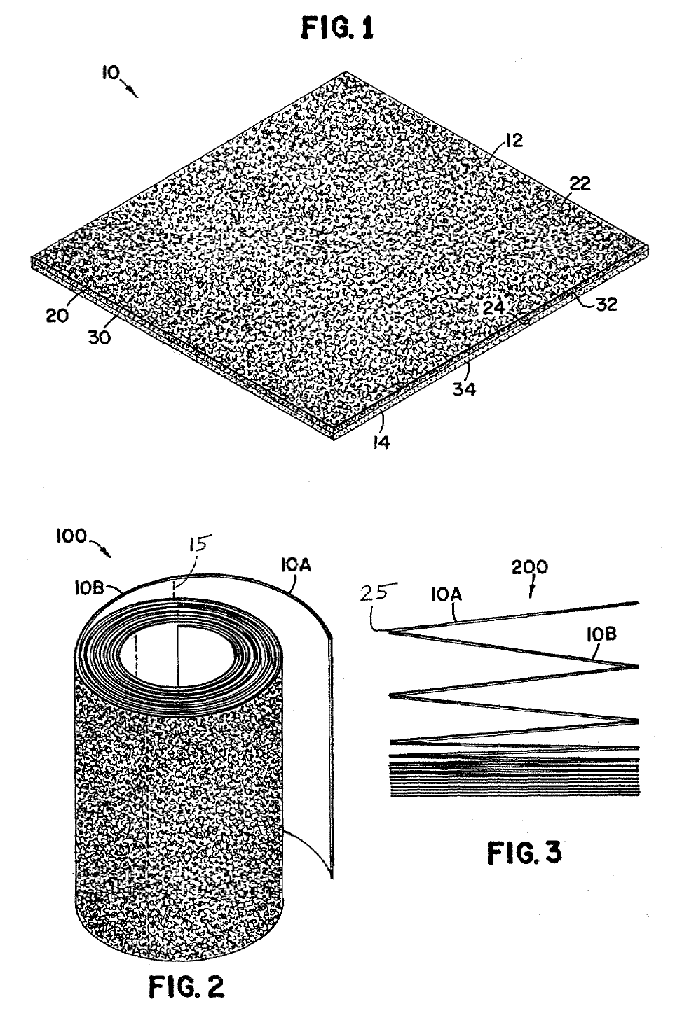

Referring now to the figures, and FIG. 1 in particular, a wipe 10 is provided. Wipe 10 is a sheet-like structure, with a first surface 12 and a second opposite surface 14. Wipe 10 also has side edges that extend between surfaces 12, 14 that form a perimeter.

Wipe 10 is a multi-layered product, having a first layer 20 and a second layer 30.

Layers 20, 30 extend throughout wipe 10 and each layer 20, 30 is preferably continuous and contiguous. The overall thickness of wipe 10, between first surface 12 and second surface 14, is preferably constant; one or both of surface 12, 14 may have a pattern imparted therein, as will be described below. Wipe 10 is sufficiently flexible to be held by a user and to conform to surfaces being cleaned.

First layer 20 has a first surface 22 and an opposite second surface 24. Similarly, second layer 30 has a first surface 32 and an opposite second surface 34. When present in wipe 10, second surface 24 of layer 20 is adjacent first surface 32 of second layer 30. In a two-layer wipe 10, first surface 22 of first layer 20 forms first surface 12 and second surface 34 of second layer 14 forms second surface 14.

First layer 20 is a compressible and flexible foam material. First layer 20 may alternately be referred to herein as foam layer 20. Foam layer 20 comprises melamine-based foam, which is typically open cell. The foam is preferably lightweight; with a very low density of about 2 to 20 kg/m³; some foam layers 20 have a density of about 5 to 15 kg/m³, or even about 8 to 12 kg/m³. The foam also is preferably resilient, capable of withstanding an indentation of at least 30 N, or at least 40 N.

For wipe 10, foam layer 20 is at least 1 mm thick. Foam layer 20 is additionally no thicker than 1 cm, usually no thicker than 5 mm, and in most embodiments is no thicker than 3 mm. In some embodiments, foam layer 20 is about 1 to about 3 mm thick, which includes about 1.5 to 3 mm or 2.5 mm thick, and 2 mm thick.

In many embodiments, melamine-based foams are flexible open-cell foams and are basically characterized by a very low density. They also have good qualities of acoustic and thermal insulation, and good chemical resistance to solvents and corrosive agents. These foams also have acceptable liquid-absorbing capacity.

One particular material suitable for layer 20 is a flexible, lightweight melamine-based open-cell foam commercially available as “Willtec” foam from Illbruck Foamtec Inc. This particular foam has a density of about 10 kg/m³ and an indentation force of greater than 45 N. In wipe 10, foam layer 20 is no more than 1 cm; “Willtec” foam, as obtained from Illbruck, is present as a large block of melamine foam that is approximately 10-14 inches (25-35 cm) tall×48 inches (122 cm) wide×96 inches (244 cm) long.

To provide foam layer 20 (e.g., at least 1 mm thick, no thicker than 1 cm, usually no thicker than 5 mm, or no thicker than 3 mm), in one embodiment, a block of foam (as obtained from Illbruck or other supplier) is placed on a horizontal slitting machine with the large face, e.g., 48 inch (122 cm)×96 inch (244 cm) face, resting on a surface, such as a table. The material is then introduced to a horizontal slitting blade, which cuts a desired thickness as the block passes into the blade. The block is cut across the width, e.g., the 48 inch (122 cm) width, as the block moves along the length, e.g., the 96 inch (244 cm) length. Common industry terms for such a process include “slitting” or “skiving.” A plurality of sheets, e.g., 48 inch (122 cm)×96 inch (244 cm), is obtained.

Attached to foam layer 20 is second layer 30, which is a carrier layer for first layer 20, providing flexural strength to wipe 10. In order to obtain benefits of the carrier layer, second layer 30 is not the same as foam layer 20. Second layer 30 generally has different surface properties than foam layer 20.

The texture of second layer 30 is often different from that of foam layer 20, which is preferred when providing a wipe with two different surfaces, e.g., a scrubbing surface and a wiping surface. The color of second layer 30 may be different from the color of foam layer 20, to facilitate differentiation between the two sides.

Examples of materials suitable for second layer 30 include synthetic foams (e.g., polystyrene, polyester, polyurethane, etc.), natural foams (e.g., cellulose), scrims or screens, woven, nonwoven or knitted materials, and lofty nonwoven materials. Other materials would also be suitable for second layer 30.

Layers 20 and 30 may be held together by any suitable adhesive means. Examples include providing a separate adhesive layer such as a solid layer that can be melted (e.g., a hot melt adhesive) or a liquid adhesive that is applied to one or both layers 20, 30. Alternately, layers 20, 30 could be thermally bonded together, but the application of heat and pressure, which results in one or both of layers 20, 30 partially melting.

A first particular example of wipe 10 included a 2 mm thick layer of melamine-based open cell foam adhered to a nonwoven polypropylene material. The nonwoven material was light green and the melamine foam was white. The nonwoven material had a basis weight of 0.88 oz/yd², and a thickness of 0.29 mm. The tensile strength of the nonwoven material (as per ASTM D 5034-95) was 46 N per 2.5 cm in the machine direction and 18 N per ⅖ cm in the cross-direction. The elongation (as per ASTM D 5034-95) was 44% in the machine direction and 82% in the cross-direction. The two layers were adhered together with a polyamide hot-melt adhesive on a nonwoven carrier, the adhesive having a DSC melting point of 105° C., heat resistance to 125° C., and a dry heat activation range of 113-124° C. The nonwoven material had an embossed pattern, 1 mm diamonds approximately 2 mm apart.

A second particular example of wipe 10 included a 2 mm thick layer of melamine-based open cell foam adhered to an open cell, polyester and polyurethane foam. The polyester and polyurethane foam was green and the melamine foam was white. The foam had about 65 pores/inch throughout. The foam material had a density of 2.0 lbs/ft³, and a thickness of about 2 mm. Per ASTM D3574, the tensile strength of the foam material was 25 psi, the tear strength was 2.0 lb/inch, and the elongation was 125%. The two layers were adhered together with a polyamide hot-melt adhesive on a nonwoven carrier, the adhesive having a DSC melting point of 105° C., heat resistance to 125° C., and a dry heat activation range of 113-124° C.

Wipe 10 is particularly suited to be used as an article for cleaning surfaces in residential (e.g., household tasks such as wiping spills, dusting, scrubbing counters, boat cleaning, vehicle trim washing, etc.) or professional/commercial (e.g., factories, laboratories, hospitals, etc.) uses. The liquid absorbing nature of foam layer 20 is conducive to using wipe 10 to clean up spills, wipe surfaces, and carry and adsorb liquid cleanser. The open cell nature of foam layer 20 is conducive for collecting dust, crumbs, and other small particles. Second layer 30 provides further characteristics to wipe 10.

Wipe 10 may be provided as a single sheet, as illustrated in FIG. 1, or a plurality of wipes 10 may be provided as a product. Referring to FIG. 2, a plurality of wipes 10, designated as wipe 10A and wipe 10B, are provided in a roll 100. Wipes 10A and 10B are provided as part of an elongate web of material, with wipes 10A and 10B connected together and defined by perforation 15. Perforation 15 facilitates removal of a single wipe, such as wipe 10A, when needed. In this embodiment, roll 100 does not include a core, although other embodiments may.

FIG. 3 illustrates another embodiment of a plurality of wipes 10, designated as wipe 10A and wipe 10B, now provided as a stack 200. Wipes 10A and 10B are provided as part of an elongate web of material, folded in an accordion manner to connect the wipes. Wipes 10A, 10B meet at fold 25, which may include a perforation.

Either configuration, roll 100 or stack 200, may be housed in a container or package, or be free-standing. Other configurations, with multiple wipes 10 connected or not, are within the scope of this invention.

Although not preferred, wipe 10 may be used in combination with solid or liquid adjuvants, such as cleaners. These adjuvants may be provided to wipe 10 or the surface being contacted at the time when wipe 10 is used, or, these adjuvants may be provided to wipe 10, e.g., impregnated into or coating onto, during the manufacture of wipe 10.

The invention has been described with reference to various specific and preferred embodiments and techniques. It is understood that the features and elements described herein may be used interchangeably among the embodiments. It will be apparent to one of ordinarily skill in the art that many variations and modifications may be made while remaining within the spirit and scope of the invention.

What is claimed:

1. A wipe comprising:
(a) an open cell melamine-based foam layer having a thickness of about 1-3 mm; and
(b) a carrier layer continuous and contiguous with, and adhesively attached to, the melamine-based foam layer, the carrier layer not being open cell melamine-based foam.

2. The wipe according to claim 1, wherein the melamine-based foam layer has a thickness of about 2 mm.

3. The wipe according to claim 1, wherein the carrier layer is a foam material.

4. The wipe according to claim 3, wherein the foam material is polyester, polyurethane, or a combination thereof.

5. The wipe according to claim 1, wherein the carrier layer is a nonwoven material.

6. A method of making a wipe, comprising:
(a) providing a thick layer of melamine-based foam material;
(b) forming a plurality of thin layers from the thick layer of melamine based-foam material;
(c) adhering one of the thin layers of melamine based-foam material to a carrier layer.

7. The method of claim 6, wherein forming a plurality of thin layers from the thick layer comprises:
(a) slitting the thick layer of melamine based-foam material.

8. The method of claim 7, wherein slitting the thick layer of melamine based-foam material comprises:
(a) slitting the thick layer of melamine based-foam material to form a plurality of 1-3 mm thick thin layers.

9. The method of claim 6, wherein adhering one of the thin layers of melamine based-foam material to a carrier layer comprises:
(a) adhering one of the thin layers of melamine based-foam material to a foam layer.

10. The method of claim 6, wherein adhering one of the thin layers of melamine based-foam material to a carrier layer comprises:
(a) adhering one of the thin layers of melamine based-foam material to a nonwoven layer.
